(19) United States
(12) Patent Application Publication
(10) Pub. No.: US 2014/0183427 A1
(43) Pub. Date: Jul. 3, 2014

(54) Rope Rolling Structure of a Hand Puller

(71) Applicant: Win Chance Metal Co., Ltd., Changhua City (TW)

(72) Inventor: Wen Cheng Chang, Changhua City (TW)

(73) Assignee: Win Chance Metal Co., Ltd., Changhua City (TW)

(21) Appl. No.: 14/071,747

(22) Filed: Nov. 5, 2013

(30) Foreign Application Priority Data
Jan. 3, 2013 (TW) 102100081

(51) Int. Cl. B60P 7/08

(52) U.S. Cl. CPC B60P 7/083
USPC 254/218

(57) ABSTRACT

A rope rolling structure of a hand puller contains a fixing member and a rope roller. The fixing member includes a base, a central shaft assembly, two ratchet wheels, and a lower stopping piece. The base has a first segment and a second segment, and the first segment has two opposite orifices. The central shaft assembly is pivoted with the two opposite orifices. Each ratchet wheel includes plural ratchets. The lower stopping piece is fixed on the base and engages with or disengages from one of the plural ratchets. The rope roller has a rolling post and two stop disks, the rolling post has an opening, each stop disk has two apertures, such that the rope roller inserts into and retains with the central shaft assembly by using the two apertures, so when the central shaft assembly rotates, the rope roller is driven by the central shaft assembly to rotate.

### BACKGROUND OF THE INVENTION

1. Field of the Invention

The present invention relates to a hand puller, and more particularly to a rope rolling structure of a hand puller which not only can roll a mesh belt, but also can roll a rope.

2. Description of the Prior Art

A conventional hand puller is used to position merchandise on a stack board or a platform by matching with a rope.

An improved hand puller contains a fixing member and a driving member for matching with a wide-plate mesh belt.

The fixing member has a base, a central shaft assembly, and two ratchet wheels, and the ratchet wheels are fixed by a lower stopping piece.

The driving member has one end for connecting with the central shaft assembly and a lower stopping piece for moving flexibly. However, the improved hand puller is only applicable for rolling a wide-plate mesh belt, but cannot roll a rope with a circular cross section and a steel cable. Because the wide-plate mesh belt is rolled and inserted into the central shaft assembly, and after the central shaft assembly rotates, a pressing part of a ribbon is limited, and the rope and the steel cable cannot be rolled and positioned on the central shaft assembly in turn.

The present invention has arisen to mitigate and/or obviate the afore-described disadvantages.

### SUMMARY OF THE INVENTION

The primary object of the present invention is to provide a rope rolling structure of a hand puller which not only can roll a mesh belt, but also can roll a rope.

Another object of the present invention is to provide a rope rolling structure of a hand puller.

To obtain the above objectives, a foldable storage basket/box contains: a fixing member and a rope roller.

The fixing member includes a base, a central shaft assembly, two ratchet wheels, and a lower stopping piece.

The base has a first segment and a second segment, and the first segment has two opposite orifices defined on two sides thereof.

The central shaft assembly is pivoted with the two opposite orifices of the base so that the central shaft assembly rotates along the two opposite orifices.

Each of the two ratchet wheels includes a plurality of ratchets arranged around an outer peripheral side thereof, and the two ratchet wheels is mounted on two ends of the central shaft assembly.

The lower stopping piece is movably fixed on the base and is used to engage with or disengage from one of the plurality of ratchets of each ratchet wheel.

The rope roller is comprised of a rolling post and two stop disks mounted on two sides of the rolling post, and the rolling post has an opening formed thereon, each stop disk has two apertures arranged thereof, such that the rope roller inserts into and retains with a middle section of the central shaft assembly by using the two apertures so that when the central shaft assembly rotates, the rope roller is driven by the central shaft assembly to rotate.

### BRIEF DESCRIPTION OF THE DRAWINGS

FIG. 1 is a perspective view showing the exploded components of a rope rolling structure of a hand puller according to a first embodiment of the present invention.

FIG. 2 is a perspective view showing the assembly of the rope rolling structure of the hand puller according to the first embodiment of the present invention.

FIG. 3 is a cross sectional view showing the assembly of the rope rolling structure of the hand puller according to the first embodiment of the present invention.

FIG. 4 is a cross sectional view showing the operation of the rope rolling structure of the hand puller according to the first embodiment of the present invention.

FIG. 5 is another cross sectional view showing the operation of the rope rolling structure of the hand puller according to the first embodiment of the present invention.

FIG. 6 is a perspective view showing the exploded components of a rope rolling structure of a hand puller according to a second embodiment of the present invention.

FIG. 7 is a perspective view showing the exploded components of the rope rolling structure of the hand puller according to the second embodiment of the present invention.

FIG. 8 is a cross sectional view showing the operation of the rope rolling structure of the hand puller according to the second embodiment of the present invention.

FIG. 9 is a cross sectional view showing the assembly of a rope rolling structure of a hand puller according to a third embodiment of the present invention.

FIG. 10 is a plan view showing the assembly of a rope rolling structure of a hand puller according to a fourth embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

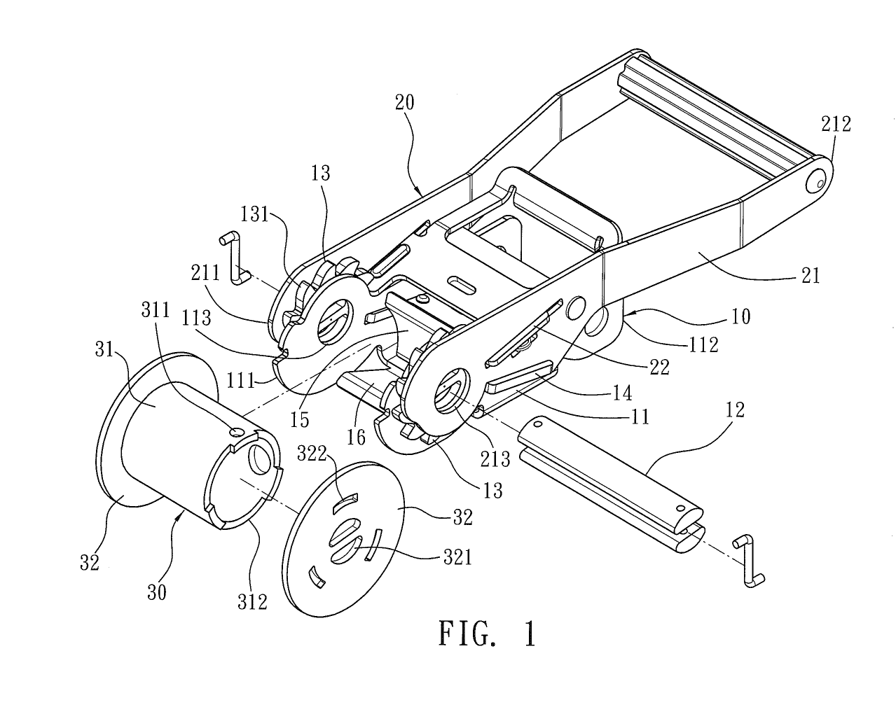

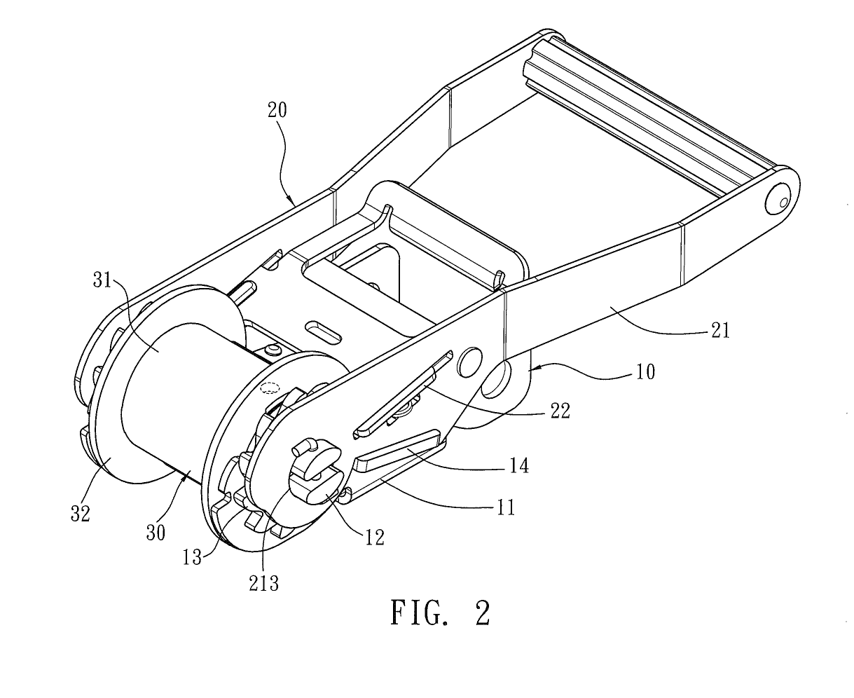

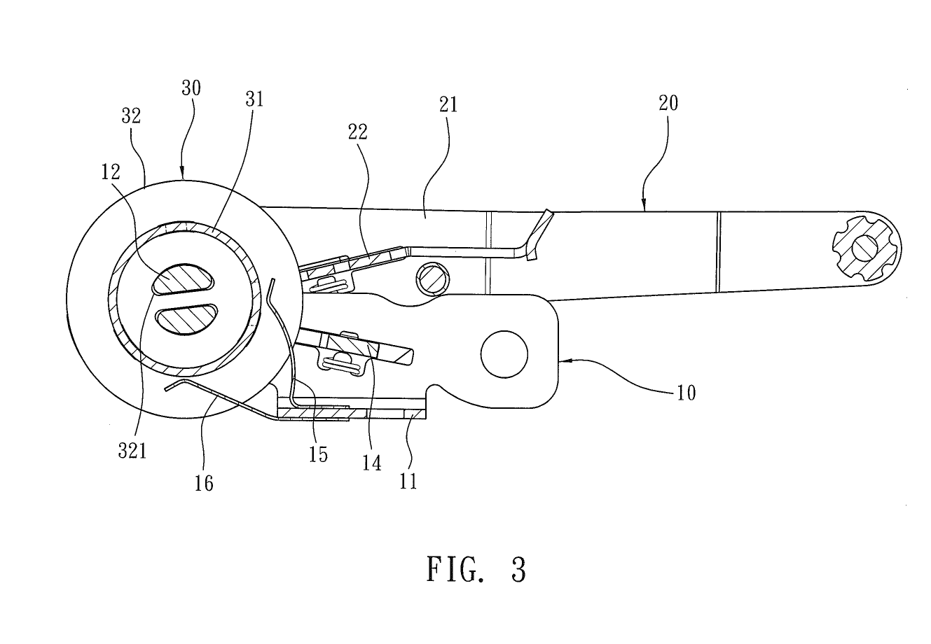

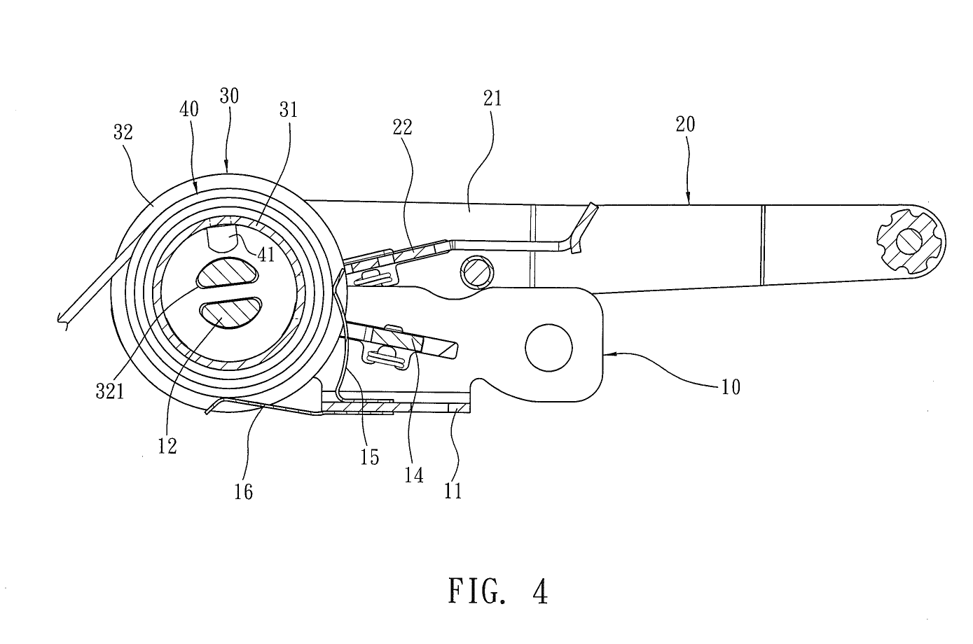

With reference to FIGS. 1 to 3, a rope rolling structure of a hand puller according to a first embodiment of the present invention comprises: a fixing member 10, a driving member 20, and a rope roller 30 for matching with a rope 40 (as illustrated in FIG. 4).

The fixing member 10 includes a base 11, a central shaft assembly 12, two ratchet wheels 13, and a lower stopping piece 14.

The base 11 has a first segment 111 and a second segment 112, and the first segment 111 has two opposite orifices 113 defined on two sides thereof.

The central shaft assembly 12 is comprised of two semi-circular bars pivoted with the two opposite orifices 113 of the first segment 111 of the base 11 so that the central shaft assembly 12 rotates along the two opposite orifices 113.

Each of the two ratchet wheels 13 includes a plurality of ratchets 131 arranged around an outer peripheral side thereof, and the two ratchet wheels 13 are mounted on two ends of the central shaft assembly 12.

The lower stopping piece 14 is movably fixed on the base 11 and is used to engage with or disengage from one of the plurality of ratchets 131 of each ratchet wheel 13.

The base 11 of the fixing member 10 also has a first clamping piece 15 and a second clamping piece 16 for clamping the central shaft assembly 12 flexibly.

The driving member 20 includes a rotary holder 21 and an upper stopping piece 22.

The rotary holder 21 has a first end 211 and a second end 212, and the first end 211 has two opposite holes 213 defined on two sides thereof so that the two ends of the central shaft assembly 12 insert into and rotate along the two opposite holes 213, hence the central shaft assembly 12 rotates along the two opposite holes 213.

The upper stopping piece 22 is movably disposed on the rotary holder 21 and is applied to engage with or to disengage from one of the plurality of ratchets 131 of each ratchet wheel 13.

The rope roller 30 is comprised of a rolling post 31 and two stop disks 32 mounted on two sides of the rolling post 31, and the rolling post 31 has an opening 311 formed thereon, each stop disk 32 has two semi-circular apertures 321 arranged thereof, such that the rope roller 30 inserts into and retains with a middle section of the central shaft assembly 12 by using the two semi-circular apertures 321 so that when the central shaft assembly 12 rotates, the rope roller 30 is driven by the central shaft assembly 12 to rotate. The rolling post 31 is hollow and has two retaining fringes 312 arranged around the two sides thereof, and each stop disk 32 is circular and has a plurality of pores 322 defined around the two semi-circular apertures 321, wherein the plurality of pores 322 retain with the two retaining fringes 312.

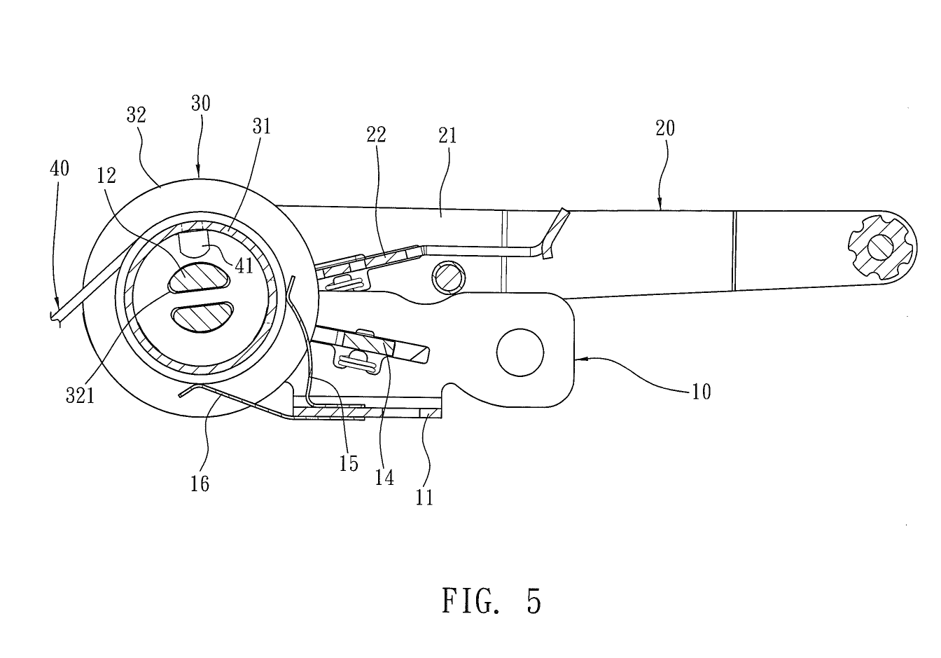

The rope 40 includes a locking portion 41 disposed on one end thereof and a hook mounted on another end thereof, wherein the locking portion 41 is inserted into and limited by the opening 311 of the rope roller 30. As shown in FIG. 4, when the driving member 20 is pushed back and forth, it drives the two ratchet wheels 13 to rotate the central shaft assembly 12, and since the rope roller 30 retains with the central shaft assembly 12, the rope roller 30 is driven by the central shaft assembly 12 to rotate, hence the rope 40 is rolled by the rolling post 31. It is to be noted that after the rope 40 is continuously rolled to contact with one of the two stop disks 32, it moves to and contacts with another stop disk 32, thus rolling the rope 40 on the rope roller 31. Thereafter, the rope 40 is clamped by the first clamping piece 15 and the second clamping piece 16. Accordingly, as illustrated in FIGS. 4 and 5, the hand puller not only can roll a mesh belt, but also can roll the rope 40.

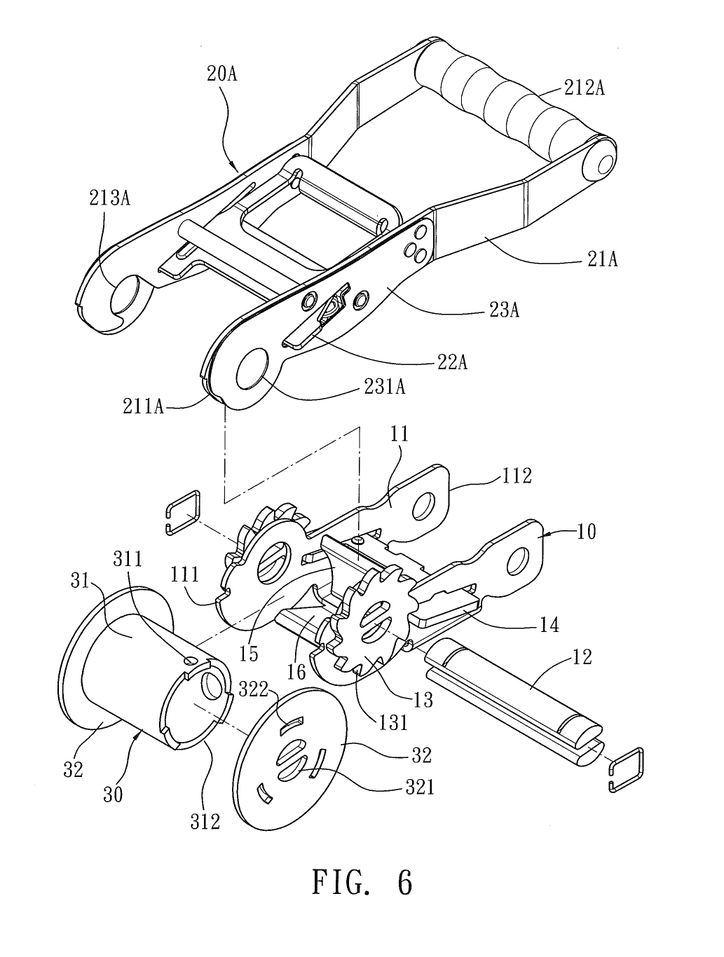

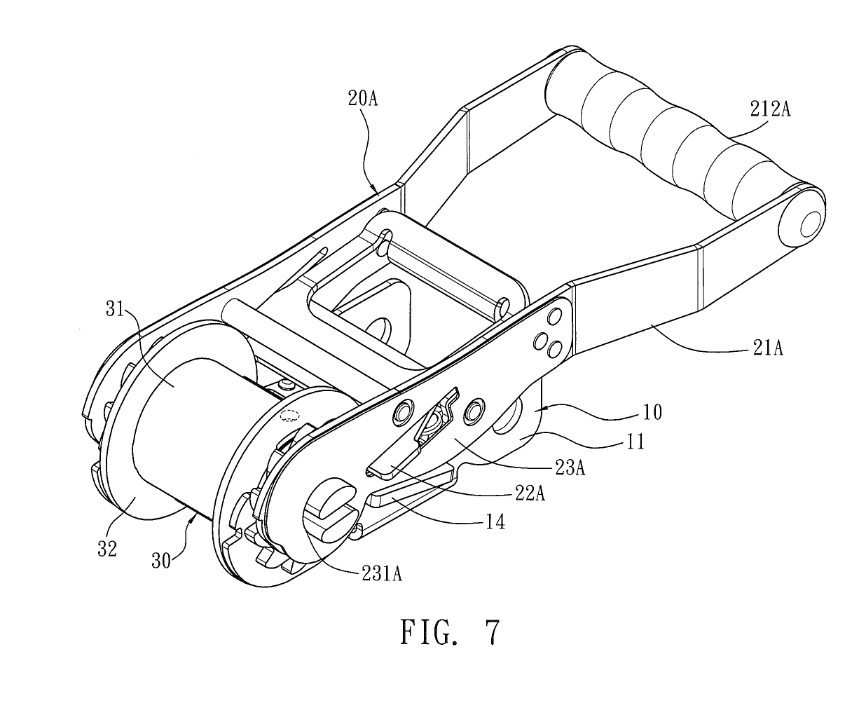

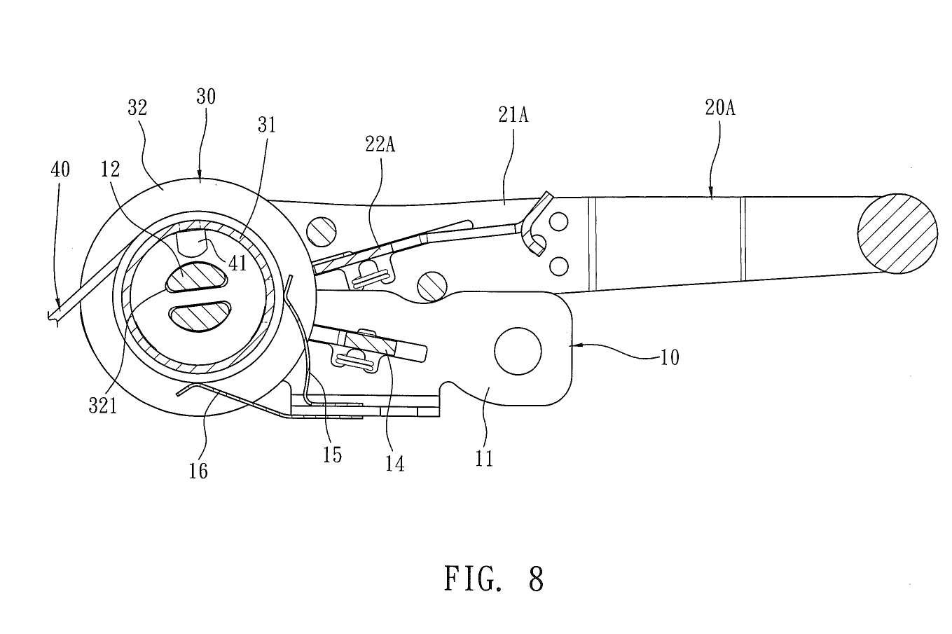

Referring to FIGS. 6-8, a difference of a rope rolling structure of a hand puller of a second embodiment from that of the first embodiment comprises: a removable driving member 20A used to replace the driving member 20 of the first embodiment.

The removable driving member 20A includes a rotary holder 21A, an upper stopping member 22A, and two resilient sheets 23A.

The rotary holder 21A has a first end 211A and a second end 212A, and the first end 211A has two oppositely through holes 213A defined on two sides thereof, and each through hole 213A has an open mouth defined on a lower side of the first end 211A, so that two ends of a central shaft assembly 12 retain with and rotate along the two oppositely through holes 213A, hence the central shaft assembly 12 rotates along the two oppositely through holes 213A.

The upper stopping piece 22A is movably disposed on the rotary holder 21A and is applied to engage with or to disengage from one of a plurality of ratchets 131 of each ratchet wheel 13.

The two resilient sheets 23A is fixed on two sides of the rotary holder 21A, and each resilient sheet 23A has a dead hole 231A for corresponding to a respective one of the two oppositely through holes 213A. When the upper stopping piece 22A moves, the two resilient sheets 23A are driven by the upper stopping piece 22A to move away from the two oppositely through holes 213A, such that the removable driving member 20A connects with or disconnects from the two ends of the central shaft assembly 12.

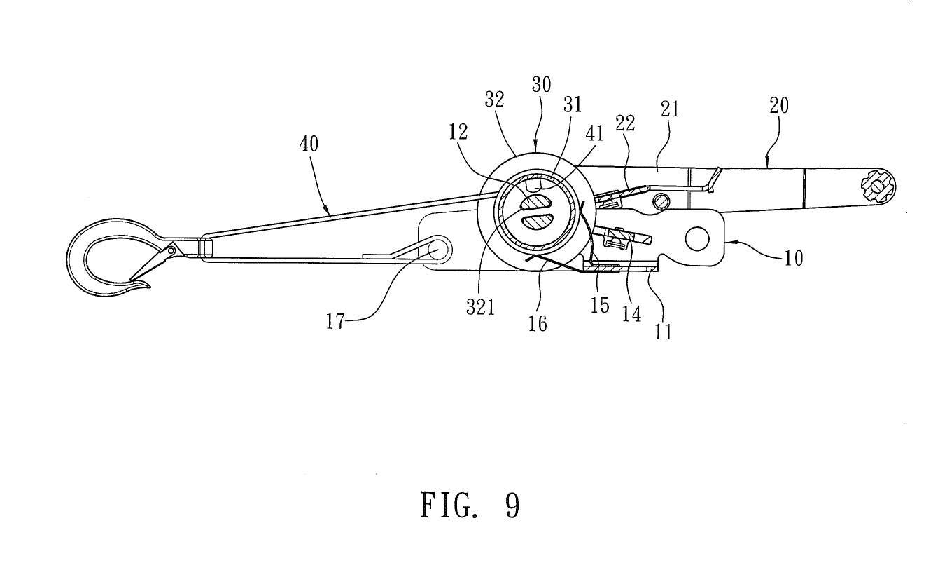

As shown in FIG. 9, a base 11 of a fixing member 10 further has a horizontal extension 17 extending outwardly from the first segment 111, and a rope 40 includes a locking portion 41 arranged on one end thereof and fixed on a rope roller 30, and another end of the rope 40 is secured on the horizontal extension 17. Moreover, a hook is defined on the rope 40 between the horizontal extension 17 and the rope roller 30.

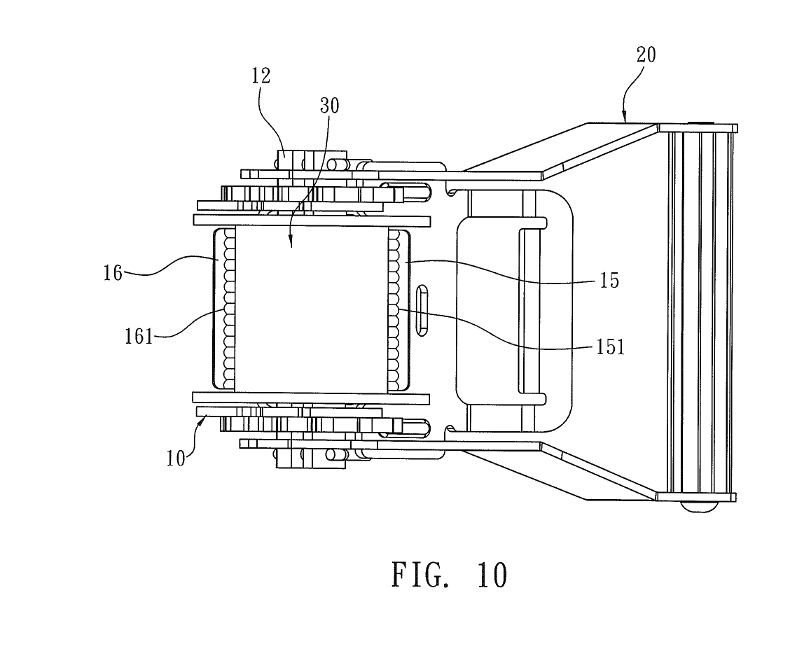

With reference to FIG. 10, the base 11 of the fixing member 10 also has a first clamping piece 15 and a second clamping piece 16 for clamping the central shaft assembly 12 flexibly, wherein the first clamping piece 15 and the second clamping piece 16 have a plurality of first waved arcuate faces 151 and a plurality of second waved arcuate faces 161 so as to roll the rope 40 in turn.

Thereby, the fixing member 10, the driving member 20, the base 11, the central shaft assembly 12, the two ratchet wheels 13, the lower stopping piece 14, the rotary holder 21, and the upper stopping piece 22 of the rope rolling structure are produced in a fixed specification and a design so that a wide-plate mesh belt is rolled directly. Likewise, the two semi-circular apertures 321 are one piece formed with the central shaft assembly 12, and the rope roller 30 includes the rolling post 31, the two stop disk 32, and the opening 311, the rope rolling structure of the present invention is capable of rolling the rope 40 with a circularly cross section, thus rolling the mesh belt and the rope 40.

While we have shown and described various embodiments in accordance with the present invention, it is clear to those skilled in the art that further embodiments may be made without departing from the scope of the present invention.

What is claimed is:

1. A rope rolling structure of a hand puller comprising: a fixing member and a rope roller;
the fixing member including a base, a central shaft assembly, two ratchet wheels, and a lower stopping piece;
the base having a first segment and a second segment, and the first segment having two opposite orifices defined on two sides thereof;
the central shaft assembly being pivoted with the two opposite orifices of the base so that the central shaft assembly rotates along the two opposite orifices;
each of the two ratchet wheels including a plurality of ratchets arranged around an outer peripheral side thereof, and the two ratchet wheels being mounted on two ends of the central shaft assembly;
the lower stopping piece being movably fixed on the base and being used to engage with or disengage from one of the plurality of ratchets of each ratchet wheel;
the rope roller being comprised of a rolling post and two stop disks mounted on two sides of the rolling post, and the rolling post having an opening formed thereon, each stop disk having two apertures arranged thereof, such that the rope roller inserts into and retains with a middle section of the central shaft assembly by using the two apertures so that when the central shaft assembly rotates, the rope roller is driven by the central shaft assembly to rotate.

2. The rope rolling structure of the hand puller as claimed in claim 1 further comprising a driving member including a rotary holder and an upper stopping piece;
the rotary holder having a first end and a second end, and the first end having two opposite holes defined on two sides thereof so that the two ends of the central shaft assembly insert into and rotate along the two opposite holes, hence the central shaft assembly rotates along the two opposite holes;
the upper stopping piece being movably disposed on the rotary holder and being applied to engage with or to disengage from one of the plurality of ratchets of each ratchet wheel.

3. The rope rolling structure of the hand puller as claimed in claim 1 further comprising a removable driving member including a rotary holder, an upper stopping member, and two resilient sheets;
the rotary holder having a first end and a second end, and the first end having two oppositely through holes defined on two sides thereof, and each through hole has an open mouth defined on a lower side of the first end, so that two ends of the central shaft assembly retain with and rotate along the two oppositely through holes;
the lower stopping piece being movably fixed on the base and being used to engage with or disengage from one of the plurality of ratchets of each ratchet wheel;
the two resilient sheets being fixed on two sides of the rotary holder, and each resilient sheet having a dead hole for corresponding to a respective one of the two oppositely through holes; when the upper stopping piece moves, the two resilient sheets are driven by the upper stopping piece to move away from the two oppositely through holes, such that the removable driving member connects with or disconnects from the two ends of the central shaft assembly.

4. The rope rolling structure of the hand puller as claimed in claim 1, wherein the rope roller matches with a rope, the rope includes a locking portion disposed on one end thereof and a hook mounted on another end thereof, wherein the locking portion is inserted into and limited by the opening of the rope roller.

5. The rope rolling structure of the hand puller as claimed in claim 1, wherein the central shaft assembly is comprised of two semi-circular bars, and each aperture is semi-circular.

6. The rope rolling structure of the hand puller as claimed in claim 1, wherein the base of the fixing member also has a first clamping piece and a second clamping piece for clamping the central shaft assembly flexibly.

7. The rope rolling structure of the hand puller as claimed in claim 1, wherein the rolling post is hollow and has two retaining fringes arranged around the two sides thereof, and each stop disk is circular and has a plurality of pores defined around the two apertures, wherein the plurality of pores retain with the two retaining fringes.

8. The rope rolling structure of the hand puller as claimed in claim 1, wherein the base of the fixing member further has a horizontal extension extending outwardly from the first segment, and the rope includes a locking portion arranged on one end thereof and fixed on the rope roller, another end of the rope is secured on the horizontal extension, and a hook is defined on the rope between the horizontal extension and the rope roller.

9. The rope rolling structure of the hand puller as claimed in claim 1, wherein the base of the fixing member also has a first clamping piece and a second clamping piece for clamping the central shaft assembly flexibly, wherein the first clamping piece and the second clamping piece have a plurality of first waved arcuate faces and a plurality of second waved arcuate faces.
